(19) United States
(12) Patent Application Publication
(10) Pub. No.: US 2026/0094200 A1
(43) Pub. Date: Apr. 2, 2026

(54) E-commerce Systems Including Cross-Selling and E-commerce for Social Media

(71) Applicant: GoVyrl, Inc., Irvine, CA (US)

(72) Inventors: Jason Goldberg, Los Angeles, CA (US); David Perry, Monarch Beach, CA (US)

(21) Appl. No.: 19/031,043

(22) Filed: Jan. 17, 2025

Related U.S. Application Data
(60) Provisional application No. 63/699,980, filed on Sep. 27, 2024.

(51) Int. Cl. G06Q 30/0601; G06Q 10/087; G06Q 30/0251

(52) U.S. Cl. CPC G06Q 30/0641; G06Q 10/087; G06Q 30/0255; G06Q 30/0631

(57) ABSTRACT

An e-commerce system and associated methods are provided to facilitate the cross-selling of products and services across virtual and physical stores, as well as through social media platforms. The system typically includes a store manager that allows a store owner to manage the characteristics of an e-commerce store, and a machine learning system trained to identify combinations of products that are likely to sell well together. A recommendation engine, including a store parser, inventory analysis logic, and recommendation logic, utilizes the machine learning system to generate recommendations for additional products to add to the e-commerce store based on a set of products available from external e-commerce stores and the store's current inventory. An optional product browser enables the store owner to review and select products from the generated recommendations. The system also includes storage for relevant data and a microprocessor to execute parts of the recommendation engine. Methods for managing an e-commerce store and adding products to a social media feed are also disclosed, leveraging the machine learning system to enhance sales and customer engagement by recommending products based on store characteristics, social media content, and customer interactions.

### CROSS-REFERENCE TO RELATED APPLICATIONS

This application claims benefit of and priority to U.S. provisional patent application Ser. No. 63/699,980 filed Sept. 27, 2024, the disclosure of which is hereby incorporated herein by reference.

### BACKGROUND

### Field of the Invention

The invention is in the field of e-commerce platforms.

### Related Art

A significant fraction of commerce now occurs over the internet. Much of this “e-commerce” occurs at online stores.

### SUMMARY

An e-commerce system provides virtual and/or physical stores to seamlessly cross-sell each other's products and/or services. In various embodiments, the selection of products and services to include in a store is facilitated by a user interface with which a store owner can add items to their online (virtual) store inventory using just a single click button or a drag-and-drop operation. Once a product is thus selected, not only is the product added to an online store also are corresponding web pages, the product photography, SKU types, SKU colors, product description, inventory levels, pricing rules, partnership terms, product reviews, and/or the like. This makes the process of adding products to a store from a source inventory effortless. Products thus added to a store may be automatically included on an associated website and/or other customer interface.

Products and services may be recommended to a store owner, for inclusion in their store. These augmented recommendations may be selected based on characteristics of the store (e.g., purpose, language, location, public or private, etc.), current inventory of the store, past or expected customers, industry trends, consumer trends, social trends, viral trends and/or the like. The recommendations may be made using a trained machine learning system (AI), a data model characterizing relationships between products or services, historical sales at other stores, A/B testing, or any combination thereof. For example, in some embodiments, recommendations are made based on the characteristics of an influencer and/or consumer. Such characteristics can include their buying patterns and/or any other of their characteristics discussed herein. Specifically, recommendations may be determined by identifying products and/or brands that have been determined to cross-sell well or who have customers having similar characteristics. These products/brands may then be recommended as good cross-selling candidates.

In some embodiments, Influencers are considered a special representative class of e-commerce participants in that an e-commerce store may be associated with one or more specific influencers.. For example, purchases at an e-commerce store tied to a specific influencer may be compared to characteristics of that influencer. Correlations between the influencer characteristics and the actual products/brands purchases may then be identified and utilized. When purchases of two or more products/brands are found to correlated with similar influencer characteristics, these two or more product/brands may be considered as potential cross-selling products. For example, if both product “A” and product “B” are found to sell well at e-commerce stores associated with influencers having characteristics set “X”, then products “A” and “B” may be considered cross-selling candidates (recommendations) at e-commerce stores associated with other influencers having “X” characteristics. The relationships between influencer characteristics and cross-selling products can be based on actual orders for the products. This has been found to be a substantial improvement over traditional cookie tracking across websites. Not only are products/brands identified as being good cross-selling candidates, but this association is further correlated with characteristics of influencers (or other store characteristics). In a specific example, a recommendation to a store owner/influencer may include: “For influencers having characteristics similar to yours, these products have been found to cross-sell well. You should consider adding these products to your e-commerce store. ” The characteristics of influencers are discussed elsewhere herein.

In various embodiments, recommendations may also be dependent on social media content, an example of an influencer characteristic. For example, a product may be recommended for inclusion in a store associated with a social media influencer based on advertisements, posted content, and/or relationships within their social media account. In a specific example, a product & partnership may be recommended based on content within a person's social media feed, comments made by their followers, and/or characteristics of their followers.

If an e-commerce store is pre-existing, an AI based recommendation logic may analyze the existing inventory and/or sales data to identify and recommend products likely to increase sales (e.g., cross-sales). In a specific example, a store that sells surfboards may be told that selling beach towels is likely to increase their sales. Further, the recommendation logic may include a specific brand of beach towel from one or more specific sources based on that brand being especially attractive to customers having similar characteristics as the store's existing customers (e.g., buyers of surf boards in a certain location and age group).

The AI based recommendation logic may also be configured to create a new marketplace from scratch by suggesting inventory without consideration of a store's existing inventory or products. For example, products for including in the inventory of a new store may be recommended based on historical sales data of other stores, a store category, other store characteristics, one or more influencers associated with the new store, product sales data, and/or a goal of maximizing profits or revenues.

Various embodiments of the invention include an e-commerce system comprising: a semi-automated store manager configured for a store owner to view and modify characteristics of an e-commerce store; a machine learning system trained to identify combinations of products that sell well together; a recommendation engine including: a store parser configured to identify a set of products or services available from external e-commerce stores, inventory analysis logic configured to identify characteristics of the e-commerce store, the characteristics including at least a current listed inventory of the e-commerce store, and recommendation logic configured to use the machine learning system to generate recommendations of additional products to add to the e-commerce store based on at least the identified set of products and the current listed inventory; an optional product browser configured for the store owner to review the generated recommendations and to select products from the generated recommendations to be added to the e-commerce store; storage configured to store the characteristics of the e-commerce store, data characterizing the set of products available from external e-commerce stores, and/or the machine learning system; and a microprocessor configured to execute at least part of the recommendation engine.

Various embodiments of the invention include a method of managing an e-commerce store, the method comprising: receiving characteristics of the e-commerce store, the received characteristics including one or more of: a current inventory, a store purpose, a sales history, a customer history, social media content, and/or characteristics of a related physical store; receiving a set of available products available from one or more external source (e.g., supplier), the one or more external source optionally including at least one external e-commerce store; identifying a selection of one or more products to be added or removed from the e-commerce store, the selection being from the set of available products, wherein the identification is based on the characteristics of the e-commerce store, and the identification is made using a machine learning system trained to identify products likely to increase profit (sales, etc.) at the e-commerce store; presenting the identified products to an owner of the e-commerce store; receiving one or more selection of products from among the identified products or services, the selection being received from the owner; automatically adding the selection of products to the e-commerce store, the addition of the selection of products including generation of a user interface configured for a customer to view the selection of products and services and including generation of a data record indicating sources of the selected products or services; and optionally presenting the user interface to a customer. This technology enables traditional online stores to immediately adopt virtual warehousing (e.g., not having to handling inventory, freight, logistics, inventory insurance, restocking fees, package returns, clearance sales etc.) In some embodiments, the source of a product can retain the product until a sale has occurred, at which time it can be shipped directly to a buyer or via a seller.

Various embodiments of the invention include a method of adding products to a social media feed, the method comprising: receiving characteristics of a social media account, the received characteristics including one or more of: a current inventory, a social media account purpose, a sales history, a customer history, identifiers of followers of the social media account, social media content, and/or characteristics of a related physical store, wherein the social media content includes, postings including textual content, postings including audio content, postings including image (still or video) content, and/or follower responses to postings; receiving a first set of available products available from one or more external source, the one or more external source optionally including at least one external e-commerce store optionally parsing the social media content to generate tokens representative of the social media content; providing the current inventory of an e-commerce store associated with the social media account, to a trained machine learning system, wherein the machine learning system is trained to identify products likely to increase sales at the e-commerce store; providing the social media content or the tokens to the machine learning system; providing the first set of available products to the machine learning system; identifying a second set of one or more products to be added to an e-commerce store associated with the social media account, the second set being selected from the from set of available products, wherein the identification is based on the provided social media content or the tokens, characteristics of the social media account, the identification being made using the machine learning system; optionally presenting the second set of one or more products to an owner of the e-commerce store associated with the social media account; optionally receiving one or more selection of products from among the second set, the selection being received from the owner; automatically adding products from among the second set to the e-commerce store, the added products optionally being limited to those in the selection received from the owner, the addition of the selection of products including generation of a user interface configured for a customer to view the selection of products and services and including generation of a data record indicating sources of the selected products or services.

Various embodiments of the invention include an e-commerce system comprising: a store manager configured for a store owner to view and modify characteristics of an e-commerce store; statistical analysis logic configured to identify combinations of products that sell well together; a recommendation engine including: a store parser configured to identify a set of products or services available for drop shipping from external sources, inventory analysis logic configured to identify characteristics of the e-commerce store, the characteristics including at least a current listed inventory of the e-commerce store, and recommendation logic configured to use statistical analysis logic to generate recommendations of additional products to add to the e-commerce store based on at least the identified set of products and the current listed inventory; a product browser configured for the store owner to review the generated recommendations and to select products from the generated recommendations to be added to the e-commerce store; storage configured to store the characteristics of the e-commerce store, data characterizing the set of products available from external e-commerce stores, and/or the machine learning system; and a microprocessor configured to execute at least part of the recommendation engine.

### BRIEF DESCRIPTION OF THE DRAWINGS

FIG. 1 illustrates an e-commerce system, according to various embodiments of the invention.

FIG. 2 illustrates methods of adding inventory to a store, according to various embodiments of the invention.

FIG. 3 illustrates methods of adding products to a social media feed, according to various embodiments of the invention.

FIG. 4 illustrates methods of generating an e-commerce store associated with an influencer, according to various embodiments.

### DETAILED DESCRIPTION

As used herein, the term “customer” is used to refer to a person that may purchase a product or service a brick & mortar store and/or an e-commerce store.

As used herein, the term “store owner” is used to refer to the person or other entity that controls, manages, and/or owns an online and/or brick-&-mortar store.

As used herein, the term “source” is used to refer to an entity from which a product may be obtained. A source can include, for example, physical inventory in a warehouse or retail establishment controlled by the owner of a store, a manufacturer that can produce the product on demand, a wholesale supplier, or an external e-commerce store, e.g., a different e-commerce store than that offering the product for sale. A source can include an independent e-commerce store or an e-commerce store that is part of an e-commerce platform that includes independent or non-independent stores. In a specific example, using the systems and method described herein, a marketplace such as Amazon. com may function as a source of products or services to independent e-commerce stores, Likewise, an online and/or brick & motor retailer may function as a source of products or services. Optionally, a source is willing to dropship products to a customer. A source may be a non-independent e-commerce store within a closed marketplace such as Amazon or eBay, and as a source may supply an independent e-commerce store on a platform such as Shopify. Likewise, a non-independent story may act as a source for an independent store.

As used herein, the term “products” is used to represent any goods that may be traded or given. While many examples discussed refer to “products,” the systems and methods discussed herein are generally applicable to both products and/or services. For example, Recommendation Logic 128 may be configured to recommend to an e-commerce store offering a service that the store carry products related to that service.

As used herein, the term “store” is used to represent an entity that sells products or services. Typically, an e-commerce store includes webpages or other internet content that is configured to promote the products or services for sale. As is described elsewhere herein, a store may be part of an independent website or part of an e-commerce platform configured to host a plurality of independent or non-independent stores. Typically, stores that are part of a platform such as Amazon do not “own” their customers as access to the store, customers and customer data is controlled by the platform. In contrast, independent stores own their customers and customer data. An independent store may still be accessed via a third party (as an option) such as a social media application or a referral service (e.g., Yelp.com). In these examples, the third party's involvement in a store transaction typically ends with the referral of the customer to the independent store. An independent store may still be part of a marketplace such as Shopify, which supports operation of the store but does not require that the store to use a “Shopify” URL. The owner of an independent store can move the store between hosts if desired. In contrast, most of the stores currently hosted by Amazon would be considered “non-independent stores” because Amazon controls the core activities at these stores including payments, shipping, and cross-selling. It is a feature of various embodiments of the invention that the systems and methods described herein allow for cross-selling between independent stores.

As used herein, the term “independent stores” is meant to indicate stores for which each store owner has ownership of their customers. Stores in a marketplace wherein the store owners do not own their customers are not considered independent stores. For example, stores within the Amazon marketplace would not currently be considered independent stores because Amazon appears to retain ownership (e.g., control) of the customers. Specifically, if a store leaves the Amazon marketplace they lose their customers, which are retained by Amazon. Other characteristics of independent stores can include, for example, control over which products are cross-sold with their products within a marketplace, an ability to move between platforms (while retaining customers), e.g., from Shopify to Adobe Commerce, an ability to sell any legal product the owner wants, and the ability to choose which technologies are used to support their store, e.g., which payment services, which traffic tracking services, which advertisement serving services. Examples of platforms for independent stores include Shopify, Adobe Commerce, BigCommerce, Salesforce Commerce Cloud, Wix, etc.

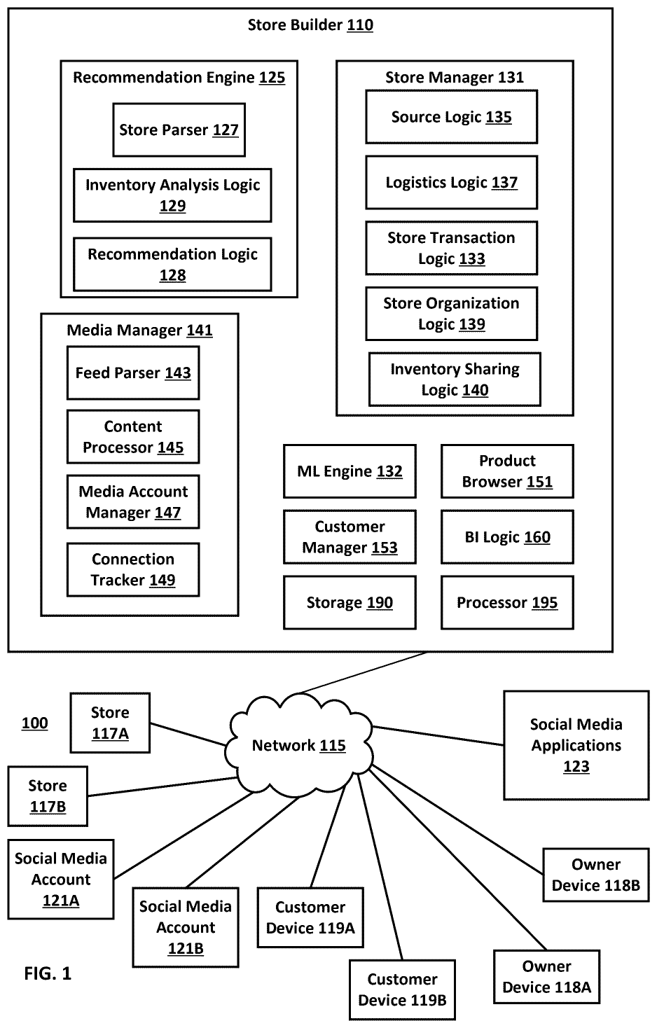

FIG. 1 illustrates an E-commerce System 100, according to various embodiments of the invention. E-commerce System 100 configured to facilitate commerce between buyers and sellers of products and/or services. E-commerce System 100 is typically distributed among a plurality of computing devices connected by one or more communication channels. For example, E-commerce System 100 may include a Store Builder 110, Stores 117, Customer Devices 119, Social Media Accounts 121, and/or one or more Social Media Applications 123, all connected by a Network 115.

Store Builder 110 is configured for a store owner to build and manage an online store. Store Builder 110 may include a variety of computing devices disposed at different geographic locations and configured to execute various operations discussed herein. For example, Store Builder 110, or sub-parts thereof, are optionally connected to Network 115. Network 115 can include the Internet, a wide area network, a telephone network, a cellular network, a wired or wireless network, and/or any other communication network configured to communicate between devices. For example, Network 115 may be configured to communicate between, Store Builder 110, Stores 117 (individually designated 117A, 117B, etc.), Owner Devices 118 (Individually designated 118A, 118B, etc.), Customer Devices 119 (Individually designated 119A, 119B, etc.), Social Media Accounts 121 (individually designated 121A, 121B, etc.), Social Media Applications 123, and/or the like.

Store Builder 110 may be used by or controlled by a third party, the owner of a store, a social media platform, an e-commerce platform, an advertising service, a referral or promotion services, and/or the like. Network 115 is optionally further configured for communication to and from a Store Manager 131. Store Manager 131 is configured for managing one or more of Stores 117 and may include, for example, logic configured to track inventory, perform financial transactions, manage suppliers & sources, organize a store layout (virtual and/or physical), provide security, etc. Store manager 131 is discussed further elsewhere herein.

Store 117 are optionally independent “stores” and/or part of a marketplace including multiple stores, such as Etsy.com, Amazon.com or Shopify.com, etc. Stores 117 may be online and/or physical (e.g., brick & mortar). For example, a hybrid shoe store may have an online presence hosted on one or more computing devices and also one or more physical locations. Devices configured to access the online presence may be located at the physical locations, may include Owner Devices 118, and/or may include Customer Devices 119. Stores 117 may also include physical locations configured to store inventory. In some embodiments, Stores 117 are disposed within a metaverse or an augmented environment. An augmented environment may include a physical location augmented using virtual reality. The augmented environment may include physical inventory and augmented reality systems configured to alter the physical inventory and/or add virtual alternatives to the physical inventor. An example of such an augmented reality system includes an AR mirror in which customers can view themselves wearing various items of clothing or jewelry. Stores 117 are optionally associated with an Influencer and/or a social media account.

Owner Devices 118 include devices, e.g., computing devices, with which an owner may access Store Builder, Stores 117 that they own, Stores 117 of third parties, social media accounts, and/or the like. Typically, Owner Devices 118 are configured to display a user interface for accessing aspects of Store Builder 110. Owner Devices 118 optionally include point of sale systems, inventory management devices, personal computers, store security systems, etc.

Customer Devices 119 can include any computing device used by a customer of Stores 117. For example, a smartphone, a personal computer, a tablet computer, a shopping terminal, glasses, a headset, an AR or VR device, a neuro-link, etc. A typical characteristic of Customer Devices 119 is a display screen, speaker, and/or microphone configured to display goods to the customer. Customer Devices 119 optionally include a terminal located for use by a customer within a physical store.

In various embodiments, Store Builder 110 is further configured to communicate with Social Media Accounts 121 and/or Social Media Applications 123. Elements of Store Builder 110 are optionally included within one or more Social Media Applications 123. A Social Media Account 121 may be a personal account or a commercial account, and may be hosted on a Social Media Application 123. For example, a Social Media Account 121 may be hosted on LinkedIn, Facebook, Instagram, WhatsApp, X (formally Twitter), YouTube, WeChat, TikTok, Weibo, Snapchat, FB Messenger, Telegram, etc.

Store Builder 110 typically includes a Recommendation Engine 125. Recommendation Engine 125 is configured to recommend, to a store owner, inventory items to include in a store, e.g., Store 117A. Recommendation Engine 125 typically includes a Store Parser 127, Inventory Analysis Logic 129 and/or Recommendation Logic 128. Recommendation Engine 125 may make use of a trained ML (Machine Learning) Engine 132. ML Engine 132 may be trained to identify products that are likely to generate customer data/business intelligence, increase attention, increase followers, increase sales (e.g., cross-sales), increase customer engagement, and/or maximize profit. ML Engine 132 can include a trained neural network, a knowledge tree, statistical analysis logic (e.g., a statics engine configured to detect correlations between sales data), an expert system, and/or the like. ML Engine 132 may be configured to use or be trained on data obtained from a plurality of independent e-commerce stores as collected by Store Builder 110. Statistical analysis logic can include any of the statistical models used to analyze sales data and/or e-commerce store performance. Statistical analysis logic may be combined with a trained machine learning system to recommend and/or identify products that sell well together and/or would sell well at a particular e-commerce store.

Store Parser 127 is configured to identify a set of products available from external sources, for example, from external e-commerce stores, wholesalers or manufacturers. In some embodiments, Store Parser 127 is configured to navigate online e-commerce stores and generate an inventory of products from data collected during this navigation. The information gathered can include product details, pricing (e.g., reseller discounts), delivery options, quantity, geographical information, etc. The information gathered may be publicly available and/or private. For example, in some cases Store Parser 127 is configured to retrieve data from a private API of an external source. Such retrieved data may include wholesale pricing, inventory levels, shipping alternatives, inventory location, and/or the like.

In typical embodiments, Store Parser 127 is configured to navigate external sources that have agreed to share their inventory within a network of e-commerce stores and sources that have agreed to share and cross-sell their inventory. As is discussed elsewhere herein, this agreement may include specific products as being available for cross-selling and/or may include specific sales terms. Store Parser 127 is optionally configured to Identify identical products available from different sources. Store Parser 127 may also be configured to parse e-commerce sources that without an inventory sharing agreement.

In alternative embodiments, Store Parser 127 is configured to receive inventory data sent from third party e-commerce stores and/or other product or service sources. For example, a wholesaler or other product source may send updated inventory and/or pricing information to Store Parser 127 on a periodic basis.

Inventory Analysis Logic 129 is configured to Identify characteristics of the e-commerce store managed by Store Manager 131, e.g., a non-external e-commerce store. In some embodiments the identified characteristics include at least a current listed inventory of the e-commerce store. The listed inventory being inventory (products or services) that are offered on the e-commerce store, as compared to physical inventory on hand. The characteristics may also include: physical inventory that is not currently listed, pricing, quantity available, backorders, sources, physical inventory storage locations, inventory at an associated brick & mortar store, shipping options, inventory costs, etc. Inventory Analysis Logic 129 is optionally used by a store owner to analyze their currently available inventory via a user interface disposed on Owner Device 118A.

Recommendation Logic 128 is configured to use the ML Engine 132 to generate recommendations of additional products to add to the e-commerce store. These recommendations are optionally based on at least members of the set of products or services identified using Store Parser 127 and/or a current listed inventory identified using Inventory Analysis Logic 129. In one example, Recommendation Logic 128 is configured to provide a specific product or set of products to ML Engine 132 and request suggestions of products that are predicted (based on training of ML Engine 132) to sell well with the specific product or set of products. In another example, Recommendation Logic 128 is configured to provide the entire inventory of the e-commers store to ML Engine 132 and request suggestions of products that are predicted (by ML Engine 132) to sell well and to increase traffic to the e-commerce store. Recommendation Logic 128 may be configured for an owner of the e-commerce store to specify specific goals for the recommendations requested from ML Engine 132. For example, a store owner may request recommendations for products that will increase sales of a specific product already in the store's inventory, a store owner may request recommendations for products that would sell to a specific customer type (e.g., gender, age, location, wealth, etc.), and/or a store owner may request recommendations for products in a specific category in which the store owner seeks to expand sales.

Recommendations received from ML Engine 132 may automatically be added to the listed inventory of the e-commerce store. Alternatively, the recommendations may be reviewed using a Product Browser 151. Product Browser 151 is configured for the store owner to review the generated recommendations and to select products from the generated recommendations to be added to the e-commerce store. This review is optionally facilitated by a user interface presented to the store owner. For example, a user interface may be configured for a user owner to view products and select which should be added to their store using “add,” “save for later” and/or “reject” options. The addition of a recommended product to the owner's store is optionally a “1-click” option. As noted elsewhere herein, the addition of a product may include automated generation of associated webpages, inventory data records, pricing data, etc.

A product may be added to the e-commerce store as part of a general product category (e.g., children's shoes) or in association with one or more products from the existing listed inventory. For example, a children's sock may be added in association with a specific set of shoes or other clothing that match that particular sock. When added in association with existing products or services, the added product may be used as an “upsell” or “cross-sell” of the associated product(s), and/or the added product may be positioned in the e-commerce store relative to the associated products(s). For example, the added product may be displayed on a same page, on a checkout page of the associated product(s), and/or within a same menu as the associated product(s). Cross-selling includes selling or promotion of a second product when a customer has shown interest in a first product. For example, attempting to sell both products together to the customer. Upselling includes selling or promotion of a second more expensive product when a customer has shown interest in a first product.

Recommendation Logic 128 is optionally configured to utilize other approaches to recommending products to include in an e-commerce store, in addition to or as an alternative to ML Engine 131. For example, Recommendation Logic 128 may also be configured to recommend products based on a knowledge graph, statistical analysis of past sales across a plurality of independent stores, A/B test results, and/or the like. For example, Recommendation Logic 128 may perform statistical and/or correlation calculations to determine brand/product popularity, what brand is the most desirable for a particular product, identifying which stores are most popular for cross-selling particular products or brands, detection of sales trends and increases, and/or the like. In one example, Recommendation Logic 128 may recommend a source for a particular brand based on how may stores have requested and/or actually sold products from that source. In another example, Recommendation Logic 128 may recommend a product based on a detected inflection point in the increase in sales of that product—indicating an accelerating rise in popularity. In this case, a frequency of which a product is recommended by Recommendation Logic 128 may be a function of a sales volume (or rate of increase thereof) of the product at other stores. In a specific example, a product experiencing an accelerating increase in sales at a brick & mortar or e-commerce store may be recommended more often for sale at other stores by Recommendation Logic 128.

Recommendations made using Recommendation Logic 128 are typically not only based on characteristics of a particular store. Rather they may be-based on information derived from a network including a plurality of independent stores, including a network of brands. For example, Recommendation Logic 128 may recommend that an electric toothbrush be offered to a customer interested in an electric shaver. Further, based on data collected across a network of brands and independent stores, Recommendation Logic 128 may recommend adding a Kendall Jenner (celebrity) toothpaste has the best likelihood of conversion with an electric toothpaste.

In some embodiments, Recommendation Logic 128 is configured to recommend bundling of products. The recommended bundles can products from multiple stores and/or sources. Examples of bundles include “A new puppy pack” “A workout in a box” “A day at the beach” “The James Bond look. ” “The Eco travel pack”. Bundles can include products that cross-sell well with each other and may be recommended as part of a bundle based on the cross-selling potential between products, as discussed elsewhere herein.

Store Builder 110 optionally further includes a Customer Manager 153. Customer Manager 153 is configured to track characteristics of individual or groups of customers of the e-commerce store. For example, Customer Manager 153 may be configured to track a purchase history of a customer, cookies associated with the customer, browsing history of a customer, customer social media connections, customer location, customer social media accounts, customer search queries, and/or the like. For example, Customer Manager 153 may track posts to a customer's social media account or posts to an influencer's social media account. Any of the customer information tracked by Customer Manager 153 may be used as a further input to Recommendation Logic 128 to generate product recommendations. In some embodiments, recommendations generated by Recommendation Logic 128 may be specific to particular customers or class of customers, based on the information tracked by Customer Manager 153. For example, a product X may be recommended only for customers in a specific geographic region and have previously viewed product “Y” on the e-commerce store. Or, product X may be recommended for customers that follow a particular influencer on social media. In such embodiments, the product X may only appear on the e-commerce store for those customers satisfying the recommendation criteria.

In various embodiments, Store manager 131 includes Source Logic 135, Logistics Logic 137, Store Transaction Logic 133, Store Organization Logic 139, Inventory Sharing Logic 140, or any combination thereof. Store Manager may be configured to manage one or more e-commerce stores, e.g., Stores 117.

Source Logic 135 is configured to manage sources of products and services offered in an e-commerce store, including products and services added to the store using Recommendation Engine 125 and Product Browser 151. For example, Source Logic 135 may be configured to track sources of products or services, wherein the sources include manufacturers, resellers, physical inventory and/or external e-commerce stores, etc. In various embodiments, Source Logic 135 is configured to identify a plurality of sources for a product and rate the identified sources based on price, delivery time, location, shipping cost, reliability, and/or product quality. For example, a first source for a pair of shoes may have a price of $20, a shipping time of 4 weeks and a shipping cost of $7, while a second source for the pair of shoes may have a price of $25, a shipping time of 2 days and a shipping cost of $10. Source Logic 135 may be configured to provide a summary score to each of these sets of characteristics based on needs of a store owner and/or customer. Source Logic 135 may be configured to monitor inventory of a product at one or more sources of that product and automatically hide that product on a website of a store when the product becomes unavailable from any source.

Source Logic 135 is optionally configured to look for alternative sources for a product based on their proximity to the customer's location. For example, if a product becomes available due to inventory issues, the Source Logic 135 may be configured to automatically prioritize alternative sources that are closer to the customer's location. If no alternative sources are available, then the product may be (temporally) removed from a store's inventory until a source becomes available.

In some embodiments, Source Logic 135 is configured to analyze alternative sources for a product at a time a purchase is made. For example, Source Logic 135 may be configured to identify a plurality of sources for a product and select an alternative source if a primary source is not able to provide the product as requested. Thus, Source Logic 135 may optimize selection of a source at a time of purchase. This optimization can be based on any source characteristics set by the store owner and/or customer. In an illustrative example, Source Logic 135 may choose an alternative source based on a price (cost at the source) change and a delivery time. In some cases, Source Logic 135 is configured to select sources based on geographic location, which can influence taxes, shipping times and shipping costs.

In some embodiments, Source Logic 135 is configured to confirm expected prices for a product on a regular basis, at a time the product is displayed to a customer, when the product is placed in a shopping cart, or when the product is purchased.

In various embodiments Store Manager 131 includes Logistics Logic 137 and Store Transaction Logic 133. Logistics Logic 137 is configured to manage delivery of purchased products from sources to customers or to an intermediate shipping location. For example, Logistics Logic 137 may be configured to send instructions to a warehouse that a specific product should be picked and provided to a designated shipping service. Store Transaction Logic 133 is configured to execute financial transactions in exchange for products (e.g., goods or services). The financial transactions optionally include both payments to the e-commerce store and payments to one or more sources. For example, following the sale of a product, funds may be received from a customer and then split between a store owner and a source based on a predetermined percentage. In some embodiments, Store Transaction Logic 133 is configured to execute payments to sources following shipment confirmation or delivery confirmation. In some embodiments, Store Transaction Logic 133 is configured to manage returns. For example, if a shipment included multiple products from different sources (perhaps sold as a bundle at a bundle discount), Store Transaction Logic 133 may be configured to redistribute revenue from the sale based on the return of one part of the bundle and to facilitate shipment of the returned item to the source of the item.

In various embodiments, Store Manager 131 includes Store Organization Logic 139. Store Organization Logic 139 is configured to control the layout of an e-commerce store, the layout including addition of products from external sources. The layout may be of a virtual e-commerce store and/or of an e-commerce store including a set of webpages. The layout may be organized by product categories such as clothing, electronics, or home goods. Within these categories, products chosen using Product Browser 151 may be further organized by subcategories like men's, women's, and children's clothing in the clothing category. The layout may also be designed to highlight featured products or sales. Furthermore, the Store Organization Logic 139 could facilitate automated page generation, creating new webpages for each product and/or category as they are added to the store. The store layout can include links between web pages, text, images and/or other devices configured for a customer to navigate a store. The store layout optionally includes a virtual environment configured for a customer to navigate between different regions of the environment, for example, using a virtual reality device (headset, glasses, etc.). Store layout can include organization of web pages and/or location of products on the web pages. Likewise, store layout can include configuration of a virtual environment. Such a virtual environment may be related to a physical environment of a brick & mortar store. For example, a shoe department in a physical store may have a virtual extension from the physical environment. Thus, a customer wearing smart AR glasses may navigate both the physical shoe department and the virtual (AR) extension. They physical/augmented reality layout of the virtual extension with respect to the physical department may be managed by Store Organization Logic 139.

In some embodiments, the Store Organization Logic 139 is configured to control the layout of a virtual e-commerce store based on customer behavior data. For instance, the layout could be dynamically adjusted to highlight products or categories that are frequently visited or purchased by the customer. Or, to highlight products that are known to cross-sell well, e.g., according to Recommendation Logic 128. In a specific example, a store based in a virtual environment may be dynamically laid out according to an individual customer's shopping history and such that products that are commonly purchased together are located proximate to each other in the virtual environment. As a customer adds products to a shopping cart, the layout of the virtual store may be dynamically reconfigured so as to bring products likely to be purchased (e.g., along with the products added to the shopping cart) closer to the customer, the determination of which products are likely to be purchased being dependent on Recommendation Logic 128, the products added to the shopping cart, and/or any of the other factors discussed herein. Optionally Store Organization Logic 139 is configured to organize Store 117A and/or a product placement thereon based on customer navigation and purchase of the product at Store 117B and/or a source of the product. In a specific example, if a customer adds a bouquet of flowers to their shipping cart in either a physical or virtual store, then the layout of the virtual store or an extension of the physical store may be reconfigured for the customer to be resented with greeting cards that would be likely to sell well along with the flowers. Note that the “shopping cart” may include items from both a virtual and physical store. For example, a physical shopping cart configured to hold physical products in a store may be associated with a virtual extension configured to hold virtual products to be purchased together with the physical products. Addition of items to the physical shipping cart may be detected using a camera, RFID, etc.

In various embodiments, the Store Organization Logic 139 is configured to facilitate the creation of personalized virtual store layouts for individual customers or for classes of customers. In some embodiments, the Store Organization Logic 139 is configured to control the layout of a virtual e-commerce store based on real-time inventory data. For instance, products or categories with high inventory levels could be prominently displayed to encourage sales and reduce inventory. Other factors that may be considered by Store Organization Logic 139 in determining a store layout can include: a customer's geographic location, seasonal sales, holidays, if the customer is in a brick & motor store, a type of device the customer is using to access the virtual store, any disabilities of the customer, a customer wish list, and/or the like. For example, during holiday seasons, a store layout may be adjusted to highlight holiday-themed decorations, products, and/or sales. The store layout may be optimized for viewing on VR devices, mobile devices, tablets, or desktop computers. The store layout may be adjusted to accommodate screen readers or other assistive technologies.

A store layout facilitated by Store Organization Logic 139 may include features configured to promote presented products. Such features can include advertisements, signage, surface textures, avatars, and/or events. For example, an avatar configured to look like an influencer associated with a store may be included in a virtual store or as an augmentation to a physical store. The actions of this avatar may be dependent on any of the customer characteristics discussed herein. For example, an avatar (optionally of an influencer) may be configured to comment on a product placed in a customer's shopping cart, may be configured to demonstrate a product to the customer, may recommend a product to the customer, may speak to the customer in the customer's language, and/or the like. In some embodiments, Store Organization Logic 139 is configured to select an avatar for presentation to a customer, from among a plurality of alternative avatars based on characteristics of the customer. For example, Store Organization Logic 139 may select an avatar configured to look and/or act like an influencer followed by the customer. Or, if the customer arrives at a virtual store via a social media account of an influencer, then Store Organization Logic 139 may be configured to include avatars associated with that influencer in a store disposed in a virtual environment.

In some embodiments, Store Organization Logic 139 is configured to control the layout of a virtual e-commerce store, the layout including coordination of locations of products in the virtual e-commerce store with locations of products within a physical retail location. This may allow for a seamless shopping experience for customers who shop both online and in-store. For example, a customer may find the same products in the same relative locations whether they are shopping in the physical store or the virtual store based in a virtual environment. In some embodiments, Store Organization logic 139 is configured to suggest layout of physical products in a physical store based on customer activity. For example, based on customer navigation in a virtual store and/or based on correlations between product purchases.

In a specific example, Store Organization Logic 139 is configured to control the layout of the virtual e-commerce store based on customer behavior data. For instance, the layout could be dynamically adjusted to highlight products or categories that are frequently visited or purchased by the customer, and products or services that are likely to be cross-sold with these products as determined by Recommendation Engine 128. In some embodiments, the Store Organization Logic 139 is configured to control the layout of the virtual e-commerce store based on the customer's shopping cart contents or search queries. For instance, products or categories that complement (e.g., cross-sell well with) the items in the customer's shopping cart could be prominently displayed in a virtual store and/or virtual extension to a physical store.

In various embodiments, Store Organization Logic 139 is configured to control the layout of the virtual e-commerce store based on the customer's social media activity. For instance, products or categories that match the customer's likes, shares, postings, and/or comments on social media could be prominently displayed. In a specific example, an image or video posted on Instagram by influencer followed by the customer may be characterized and used to select and arrange products to be presented to the customer. Store Organization Logic 139 may be configured to determine store layout based on events extracted from social media, e.g., trips, relationships, graduations, birthdays, weddings, etc.

In some embodiments, Store Manager 131 includes Inventory Sharing Logic 140. Inventory Sharing Logic 140 is configured for a store owner to designate which products offered within a (physical and/or virtual) store may be sourced to an external e-commerce store, e.g., shared. A shared product or service is one for which a first store can function as a source for other stores. The other stores will typically add the shared product or service to their inventory using Store Manager 131 based on a recommendation made by Recommendation Lotic 128. Typically, the sharing of products or services is intended to promote cross-selling and increase the average order value. A plurality of Stores 117 may share each other's products using Store Builder 110.

A store owner may select specific products for sharing or choose to share their whole inventory. In a typical example, a store owner may select to share products that they manufacture themselves (and thus have a greater margin on), but not select products that they are merely resellers of. Optionally, Inventory Sharing Logic 140 is configured to automatically select products to be shared based on a profit margin. For example, a store owner may designate that products have at least a 45% profit margin can be shared, while those with a lower profit margin cannot be shared. Optionally, Inventory Sharing Logic 140 is configured to share products based on an available inventory. For example, a product may automatically be un-shared based on the available inventory falling below a minimum threshold. If a product is thus un-shared (meaning that it is no longer available from the sourcing store) they it may automatically be removed from the inventory of a second store using Store Manager 131. Alternatively, Source Logic 135 may be configured to first look for alternative sources for the product, and only remove the product from the inventory of the second store if no suitable alternative sources (at desirable terms) are found.

A store owner may choose to share products based on their popularity or sales volume. For instance, products that are top sellers or have high customer ratings may be selected for sharing. This could help to increase the visibility and sales of these popular products across multiple e-commerce platforms. Inventory Sharing Logic 140 may be configured to share products based on their seasonality. For example, a store owner may choose to share seasonal products such as holiday decorations or summer beachwear during specific times of the year. This could help to maximize sales during peak demand periods. Inventory Sharing Logic 140 may also be configured to share products based on their uniqueness or exclusivity. For instance, a store owner may choose to share products that are handmade, custom-made, or limited edition. This could help to attract customers who are looking for one-of-a-kind or hard-to-find items. The Inventory Sharing Logic 140 may be configured to share products based on their compatibility with other products, e.g., are they likely cross-sales with other products as determined by Recommendation Logic 128. For example, a store owner may choose to share products that are often bought together or complement each other at a predesignated rate, e.g., product A is purchased with product B at least 10% of the time. Optionally, Inventory Sharing Logic 140 is configured for a store owner to designate specific cross-selling items. For example, a store owner may designate a rule: “product A can only be sold via another store (shared) if product A is sold along with products B or C.”

Inventory Sharing Logic 140 is optionally further configured for a store owner to designate revenue sharing and other terms for specific products.

For example, in various embodiments, the store owner may designate that they will split their profit margin 50/50 with a second store, that they will give a flat 20% discount for some products and a 30% discount for other products, that some produces will not be discounted. Other terms may relate to shipping costs, delivery timing, returns, liability, etc.

In some embodiments, Inventory Sharing Logic 140 is configured for a store owner to designate a tiered revenue sharing model, where the percentage of profit shared with a second store (e.g., source) varies based on the volume of sales. For instance, the store owner may designate that they will split their profit margin 40/60 with a second store for the first 100 units sold, and then adjust the split to 50/50 for any units sold beyond that threshold. In other embodiments,, Inventory Sharing Logic 140 is configured for the store owner may designate a dynamic discount model for specific products. For example, the store owner may offer a 10% discount for a product if purchased in combination with another specific product. An offered discount may be a function of available inventory.

In yet other embodiments, Inventory Sharing Logic 140 is configured for the store owner or source to designate specific terms related to product returns. For instance, the source of a product may specify that products returned within a 30-day window will be fully refunded, while products returned after this period will be subject to a restocking fee. In some embodiments, Inventory Sharing Logic 140 is configured for the store owner or source to designate terms related to product liability. For example, the source may specify that they will assume liability for any product defects or issues for a specified period after the sale, after which the liability transfers to the store owner or other party (e.g., manufacturer or supplier). In other embodiments, Inventory Sharing Logic 140 is configured for the store owner or source to designate terms related to shipping costs. For instance, a source may offer free shipping for orders above a specific value, or for customers located within a specific geographic region. Inventory Sharing Logic 140 is optionally configured for the store owner or source to designate terms related to delivery timing. For example, the store owner may guarantee delivery within a specific timeframe for orders placed before a specific cut-off time. In some embodiments, Inventory Sharing Logic 140 is configured for the store owner or source to designate terms related to product exclusivity. For instance, the store owner may specify that they will be the sole distributor of a specific product within a specific geographic region, or for a specific period. In other embodiments, Inventory Sharing Logic 140 is configured for the store owner to designate terms related to product availability. For example, the store owner may specify that the source will maintain a minimum inventory level for a specific product, ensuring the product's availability for prompt delivery customers. In some embodiments Inventory Sharing Logic 140 is configured for a store owner to designate terms for use of a trademark. For example, an influencer may or may not consent to use of their name and/or likeness in conjunction with promotion of a product or service. Such use may be included in the financial terms related to the service or product. In a specific example, with approval of an influencer, a product may customized with an image of a likeness of the influencer. Such customized product may be sold by a store associated with the influencer, sourced to another e-commerce store by the influencer, and/or sourced and sold by third parties under license from the influencer. Similar arrangements may be established for other trademarks and/or brand names as part of the financial terms related to a product or service.

Inventory Sharing Logic 140 is optionally further configured to propagate price changes between stores. For example, if the cost of a product from a source changes, the price for the product at a store may automatically be adjusted accordingly. The store owner of a store selling a product may designate that they have a fixed profit margin percentage or a fixed profit on the sale of the product they are receiving from a source. Specifically, a store owner may designate a rule that they make at least 15% or at least $5 on a sale. If a price change (or shipping cost) from a source changes such that this rule is violated, then the price at the store may automatically be changed or the product may be removed from the store. When a price changes, Inventory Sharing Logic 140 is optionally configured to identify less expensive sources. This may occur at the time the price is changed, at a time the product is placed in a shopping cart, and/or at a time the product is purchased.

In various embodiments, Inventory Sharing Logic 140 is further configured to propagate price changes between stores based on a dynamic pricing model. For instance, the price of a product at a store may be adjusted in real-time based on fluctuating market conditions, demand and supply factors, or promotional events. For example, if a sports team wins a championship, the price of products related to that sports team may be automatically adjusted. Optionally, a store owner may designate a sliding scale profit margin percentage that varies based on the volume of sales. For example, a store owner may designate a rule that they make at least 10% on a sale for the first 100 units sold, and this percentage increases to 20% for any units sold beyond that threshold in a given time period. Inventory Sharing Logic 140 may be configured to identify alternative sources based on factors other than price, such as delivery speed, customer reviews, product quality, or source reliability. This could occur at the time the price is changed, at a time the product is placed in a shopping cart, and/or at a time the product is purchased. Inventory Sharing Logic 140 may be configured to automatically adjust the price of a product at a store based on the customer's location, loyalty status, or purchase history. For example, a customer in a region with lower shipping costs may see a lower price, or a loyal customer may be offered a special discount.

Store Builder 110 optionally further includes a Media Manager 141. Media Manager 141 may be included in, for example, systems in which e-commerce stores are associated with social media accounts and/or influencers. Media Manager 141 is configured to include products or services recommended by Recommendation Logic 128 based on one or more social media accounts. Optionally, the recommended products can be added to a feed of a social media account and/or to an e-commerce store associated with the social media account. For example, recommended products could be added not just to a feed of a social media account, but also to other sections of the social media account such as the user's or influencer's profile, the influencer's stores, or highlights. The recommendations may further be based on social media accounts of the followers of the user or influencer, social media accounts that the user or influencer follow, and/or based on multiple social media accounts of the same user or influencer. Recommended products are optionally added to a feed of a social media account in the form of sponsored posts or advertisements. For example, a product source may decide they want to increase sales of a product. They can offer better terms and also pay an owner or manager of Recommendation Engine 125 for “sponsored recommendations.” In some embodiments, Recommendation Logic 128 is configured to recommend products or services based on a fee paid to an owner or manager of Recommendation Logic 128. As with the other stores discussed herein, stores associated with social media may include shared inventory for the purpose of cross-selling.

An “influencer” may be a person associated with a social media account or some other source of content. An influencer may alternatively be a legal entity and/or may publish content on platforms other than a social media feed. An influencer may be a real person (e.g., a celebrity or politician), a legal entity, and/or an AI generated avatar. For example, the New York Times or a columnist thereof may be considered an influencer in some embodiments. An influencer having few followers may be referred to as a “micro-influencer.” Influencers may have followers on a member of Social Media Applications 123. A person with a few friend followers on Facebook may be considered a micro-influencer. An influencer may be associated with one or more Stores 117. For example, a popular celebrity or a popular brand may each be associated with a particular virtual e-commerce store. Such associations may include links, posts, and/or other associations between a social media account of the influencer and the store.

In various embodiments, Media Manager 141 is configured to incorporate products or services recommended by Recommendation Logic 128 based on analysis of social media content such as posts, comments, likes, shares, and follower interactions. The products or services may be incorporated into different types of social media content such as: feeds, videos, images, audio, text posts, live streams, reels, and/or the like, on a social media account. Recommendation Logic 128 may be responsive to a user or influencer's engagement metrics, such as the number of followers, posting schedule or frequency, likes, comments, shares, or views. Further, Recommendation Logic 128 may be responsive to a user or influencer's characteristics, e.g., demographic data, such as age, gender, location, interests, and/or lifestyle.

In various embodiments, Media Manger 141 includes any combination of: a Feed Parser 143, a Content Processor 145, a Media Account Manager 147, and/or a Connection Tracker 149. These elements may be configured to interact with one or more Social Media Account 121 and/or directly with one or more Social Media Applications 123. For example, Media manager 141 may be responsive to both an influencer's X account and their Instagram account. Thus, Recommendation Engine 125 may be configured to make recommendations based on activity/characteristics of both of these accounts.

Feed Parser 143 is configured to parse social media feeds, which may include text, images, and/or other content. For example, in some embodiments, Feed Parser 143 is configured to parse postings to a Facebook, TikTok and/or Instagram account. This parsing can include extraction of text and video from the feed, tagging of images or video, analysis of original postings, replies, comments posted by followers, and/or any other social media content. The extracted content can also include likes, numbers of comments, reposts/shares, followers, follows, follower views, and/or any other common social media information. Optionally, Feed Parser 143 is configured to be registered as a follower of a social media feed. In some embodiments, Feed Parser 143 is also configured to parse third party advertisements displayed to a user of a social media account. For example, Feed Parser 143 may parse an advertisement pushed to a TikTok account by one of Social Media Applications 123, a result being that Recommendation Logic 128 may suggest a product or services that would cross-sell well with or be an alternative to a product or service promoted in the advertisement. For example, if an influencer found that their social Media Application 123 was promoting a drink brand to the influencer's followers on the influencer's social media feed, then the influencer may use Recommendation Engine 125 to identify alternative products (e.g., alternative drink brands or the same drink brand at a better price) or products that would cross-sell well with the promoted drink brand (e.g., drink cups).

In various embodiments, Feed Parser 143 is configured to parse direct messages or private messages exchanged between users on a social media platform. This parsing can include extraction of text, images, videos, audio clips, and/or any other media content from the messages. In some embodiments, Feed Parser 143 is configured to parse user profiles on social media platforms. This parsing can include extraction of user profile information such as use name, profile picture, bio, location, interests, and/or any other user profile information. In some embodiments, Feed Parser 143 is configured to parse social media feeds in real-time, allowing for immediate analysis and recommendation of products or services based on the latest social media content. In alternative embodiments, Feed Parser 143 is configured to parse social media feeds at regular intervals, such as every hour, every day, or every week, allowing for periodic analysis and recommendation of products or services based on the latest social media content. In various embodiments, Feed Parser 143 is configured to parse social media feeds based on specific triggers or events, such as a new post by a user, a new comment on a post, a new like or share of a post, or a new follower of a user. In some embodiments, Feed Parser 143 is configured to parse social media feeds in multiple languages, allowing for analysis and recommendation of products or services based on social media content in different languages. In some embodiments, Feed Parser 143 is configured to parse social media feeds using natural language processing techniques, allowing for more accurate and nuanced analysis of the text content in the feeds. In some embodiments, Feed Parser 143 is configured to parse social media feeds using audio, image or video recognition techniques, allowing for more accurate and nuanced analysis of the image content in the feeds.

Optional Content Processor 145 is configured to process text, images, video, and/or other media content to generate tokens representing that content. For example, Content Processor 145 may be configured to process images or videos and generate tokens characterizing content and/or meaning of the content. Examples of such content tagging systems include U.S. Pat. Nos. 10,223,454 and 11,256,741. The tokens generated by Content Processor 145 are optionally provided to Recommendation Logic 128 as one of the inputs used to produce product and service recommendations. Content Processor 145 may be configured to process any of the types of social media content parsed by Feed Parser 143 including, for example: audio content from social media feeds, such as voice messages or audio clips, spoken words, background sounds, music, or other audio elements; emoticons, emojis, or other symbolic content; metadata associated with social media content, such as timestamps, geolocation data, or user tags; user-generated content, such as user reviews or ratings; structured data from social media feeds, such as tables, graphs, or charts; interactive content from social media feeds, such as polls, quizzes, or games; multimedia content from social media feeds, such as GIFs, memes, or animations; live content from social media feeds, such as live streams or live chats; chat, audio, and/or events in a video game; and/or user profile information from social media feeds, such as user bios, profile pictures, or follower counts. Content Processor 145 may be configured to generate tokens representing any of such content.

Optional Media Account Manager 147 is configured to manage Social Media Accounts 121. This can include management of associations between Social Media Accounts 121, account owners, influencers, and/or e-commerce stores 117. For example, Media Account Manager 147 may be configured to manage multiple social media accounts on several Social Media Applications 123 and/or representative of several influencers. In one example Media Account Manager 147 is configured to manage a plurality of influencers, each of which have two or more social media accounts on different platforms. Media Account Manager 147 may be configured to manage social media accounts across a wide range of social media platforms, including but not limited to Facebook, Instagram, Twitter, Threads, LinkedIn, TikTok, Snapchat, and Pinterest.

The management performed by Media Account Manager 147 can include, but is not limited to, providing content from an account feed to Feed Parser 143, placement of links to one or more e-commerce store within the account feed, placement of products within the account feed (e.g., as a form of advertisements), placement of links to one or more e-commerce store within responses to other (external) accounts as responses, and/or placement of products into other (external) accounts as responses. Products placed in social media are optionally recommended by Recommendation Engine 128 and/or included within an e-commerce store associated with an influencer. For example, Media Account Manager 147 may be configured to add a link to an e-commerce store in a response made by a first influencer to a posting on the feed of a second influencer. The e-commerce store may be associated with either the first and/or second influencers. Media Account Manager 147 may be configured to add a link to a specific product or a category of products within an e-commerce store in a response made by a first influencer to a posting on the feed of a second influencer. Media Account Manager 147 may be configured to place advertisements in a Social Media Account 121. For example, such advertisements may be for products that would cross-sell well with products promoted (e.g., by Social Media Application 123) on the Social Media Accounts 121 or would be an alternative to the promoted products.

In various embodiments, Media Account Manager 147 is further configured to place promotional codes or discount offers within the account feed or within responses to other accounts and/or promotions from third parties (e.g., promotions from an instance of Social Media Applications 123). These promotional codes or discount offers can be specific to the products placed within the account feed or responses. Media Account Manager 147 may be configured to place products within a social media account feed or responses based on trending topics or popular hashtags within the social media platform. In a specific example, Media Account Manager 147 is configured to place products within a social media account feed or responses that are complementary to the products or services promoted by an influencer associated with the social media account.

In various embodiments, Media Account Manager 147 is configured to coordinate promotional campaigns among multiple influencers. For example, Media Account Manager 147 may be configured to coordinate timing of a campaign promoting a specific brand among multiple influencers. Such a campaign can include cross-posts to each other's social media accounts. Such a campaign may be organized and/or managed by a brand or product manufacturer. In a specific example, a brand interested in promoting a new product release may use Media Account Manger 147 to coordinate promotion of the new product among multiple influencers and/or e-commerce stores. Examples of such promotion may include paying a fee such that the product is recommended to the owners of multiple e-commerce stores or management of social media posts in the feeds of multiple influencers who have included the new product in their e-commerce stores.

In various embodiments, Media Account Manager 147 is configured to use Recommendation Logic 128 and/or ML Engine 132 to suggest content to include on the social media feed of an influencer to promote sales of a product or service. For example, Media Account Manager 147 may be configured to provide an instance of ML Engine 132 with a current inventory of an e-commerce store and request that ML Engine 132 provide a list of topics for social media posts that would increase the sales of the products and/or services included in the current inventory. Specifically, for an e-commerce store offering cold weather hiking gear, ML Engine 132 may respond with a list of topics including: “travel to cold weather destinations,” “joys of camping in snow,” “how to cross-country ski,” etc. These topics are selected based in likelihood of increasing sales of the cold weather hiking gear. The instance of ML Engine 132 may be trained using sales data from Stores 117 and social media feeds parsed using Feed Parser 143.

In some embodiments Store 117A can be associated with more than one influencer. For example, Store 117A may be associated with two or more influencers and/or be associated with two or more Social Media Accounts 121. One Store 117A may have multiple divisions and/or sections each associated with a different influencer and/or social media account.

Via Media Account Manager 147, an influencer and/or social media account owner may use Recommendation Engine 125, Store Manager 131, and/or Customer Manager 153 to populate one or more e-commerce stores, as described elsewhere herein. The stores may be associated with specific social media accounts, influencers, brands, product lines, topics, brick & mortar stores, events, businesses, and/or the like. The “stores” may include webpages between which a customer can navigate to see different products and services, and/or may include a set of product offerings that are shown on a social media feed. For example, a store may include a list of products that are promoted on a social media feed over time. The stores are optionally also associated with physical (brick and mortar) stores. In some embodiments, Media Account Manager 147 is configured to use Customer Manager 153 to track followers as examples of customers. Media Account Manager 147 is optionally configured for a brand and/or product manufacturer/distributor to compensate (e.g., pay) influencers for promotion of their products and/or brands.

In exemplary embodiments, the Media Account Manager 147 is configured to use Recommendation Engine 125, Store Manager 131, and/or Customer Manager 153 to populate multiple e-commerce stores associated with different social media accounts, influencers, brands, product lines, topics, brick & mortar stores, events, businesses, and/or the like. Each store may be tailored to the specific characteristics and preferences of the associated entity. In alternative embodiments, the “stores” may include not just webpages, but also mobile applications, virtual reality environments, augmented reality interfaces, or other digital platforms where customers can navigate to see different products and services. In some cases, a store may include a dynamic list of products that are promoted on a social media feed over time, with the list being updated in real-time or near real-time based on the latest product recommendations from the Recommendation Engine 125.

In some embodiments, Media Account Manager 147 is configured to use Customer Manager 153 to track followers across multiple social media platforms, providing a more comprehensive view of the customer base. The tracking of followers can include, for example, likes, posts, comments, shares, mentions, direct messages, and/or the like. Media Account Manager 147 may be configured to use Recommendation Engine 125, Store Manager 131, and/or Customer Manager 153 to populate e-commerce stores with products or services that are specifically tailored to the preferences and interests of the followers as tracked by Customer Manager 153. Media Account Manager 147 may be configured to use Recommendation Engine 125, Store Manager 131, and/or Customer Manager 153 to populate e-commerce stores with products or services that are specifically recommended for cross-selling or upselling based on the current inventory of the store and the preferences and interests of the followers tracked by Customer Manager 153. A single Store 117A may be associated with multiple social media accounts of an influencer, manufacturer, and/or other users, wherein the multiple accounts are optionally based on multiple social media platforms.

Optional Connection Tracker 149 is configured to track connections between Social Media Accounts 121. Such tracking can include, for example, which accounts follow each other, which accounts represent “friends,” the identities of accounts that respond, replay or comment on each other's feeds, direct messages between accounts, and/or other connections or interactions between accounts. In some embodiments, this information is used by Recommendation Logic 128 to recommend products to be included in an e-commerce store. As discussed elsewhere herein, connections between Social Media Accounts 121 may be used by Recommendation Engine 125, Store Manager 131, and/or Customer Manager 153 to recommend and/or add products to an e-commerce store. Connection Tracker 149 is optionally configured to determine a mapping of connections among Social Media Accounts 121, optionally across different Social Media Applications 123. Mapping across different Social Media Applications 123 is optionally based on customer purchases. For example, purchases made from two different social media accounts may be tied to the same customer based on characteristics of the purchase, e.g., credit card data, shipping address, name, etc.

In some embodiments, Connection Tracker 149 is configured to track connections between Social Media Accounts 121 based on shared interests or common topics of discussion. This information can be used by Recommendation Logic 128 to recommend products that are relevant to these shared interests or topics. In some embodiments, Connection Tracker 149 is configured to track connections between Social Media Accounts 121 based on the frequency and duration of interactions between accounts. This information can be used by Recommendation Logic 128 to recommend products that are likely to be of interest to users who interact frequently or for extended periods of time. In some embodiments, Connection Tracker 149 is configured to track connections between Social Media Accounts 121 based on the geographical location of the users. For example, their distance to a brick & mortar store associated with an e-commerce store.

In various embodiments, Store Builder 110 is configured to generate e-commerce stores associated with specific social media platform, e.g., with a specific one of Social Media Applications 123. For example, Media Manager 141 and Store Manager 131 may include embodiments having features configured to interact with a specific platform, e.g., Media Manger 141 may be configured to specifically parse content of SnapChat, X, and/or Instagram, and to post content relating to those platforms. Likewise, instances of Media Manager 141 may be configured to follow and/or login to an influencer's account on specific social media platforms. Further, Store Builder 100 may be configured for an influencer or store owner to login using a social media account, e.g., “login via Facebook” or “login via LinkedIn.”

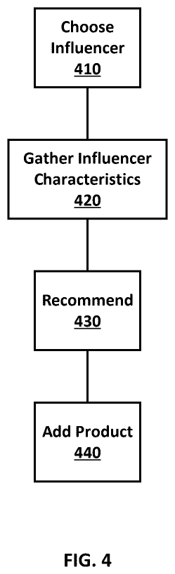

In various embodiments, Store Builder 110 is configured to generate a store for an influencer that does not have any preexisting inventory. These embodiments may be used to generate new e-commerce stores. See, for example, the discussion of FIG. 4.

Store Builder 110 optionally further includes BI Logic 160. BI Logic is configured to generate business intelligence from the use of various elements of Store Builder 110. This business intelligence may be generated from inventories and/or sales at multiple, optionally independent) e-commerce stores. In various embodiments BI Logic 160 is configured to track bestselling stores, top brands and/or products, optimal pricing, product sales ranks, sales trends, social media trends, and/or the like. For example, BI Logic 160 may be configured to recommend optimal pricing based on sales and pricing at multiple stores. BI Logic 160 may be configured to suggest pricing based on sales and pricing at multiple stores as well as the cross-selling opportunity for a product at a particular store. As such, the suggested pricing may be dependent on the strength of the cross-selling opportunity at a particular store. BI Logic 160 may also be configured to suggest social media content to influencers to include in their social media feeds. For example, BI Logic 160 may suggest that an influencer add a particular image content and/or add a discussion of a particular topic to their social in order to increase sales of one or more product. Such suggestions may be facilitated by an instance of ML Engine 132 trained to generate content topics in response to prompts including particular products and/or product characteristics. For example, using social media feeds and sales of products at related e-commerce stores ML Engine 132 may be trained to receive a prompt including characteristics of a product (e.g., “inlaid chess board” or “SKU Chess502-1”) and to suggest discussion topics of “queen's gambit,” “board game history,” “queen sacrifice” as an output. Such discussion topics may then be provided to influencers to increase sales of the chess related product on their e-commerce stores.

Store Builder 110 typically further includes Storage 190. Storage 190 is configured to store the characteristics of the e-commerce store, data characterizing the set of products available from external e-commerce stores, sales histories, social media feeds, product recommendations, statistical summaries, social network information, ML Engine 131, and/or any other information discussed herein. Storage 190 may be distributed and may include any of the types of non-transient memory discussed herein. In various embodiments, Storage 190 is configured to store: influencer characteristics, social networks, customer feedback, customer reviews, customer ratings of products, data related to the performance of the machine learning system (such as accuracy metrics, error rates, training data, etc.), data related to a store owner's preferences and settings (such as preferred sources, preferred product categories, and preferred pricing strategies, etc.), data related to a store's operational parameters (such as inventory turnover rates, average order values, sales conversion rates, etc.), data related to the store's marketing and promotional activities (such as promotional campaigns, discount offers, customer loyalty programs, etc.), data related to the store's security and privacy settings (such as user access controls, data encryption settings, privacy policies, etc.), and/or data related to the store's integration with other systems (such as payment gateways, shipping providers, customer relationship management systems, etc.).

Store Builder 110 further includes at least one Processor 195. Processor 195 includes a microprocessor (quantum, electronic or optical, etc.) configured to execute any combination of the logic discussed herein. For example, in some embodiments, Processor 195 includes a circuit configured to execute at least part of Recommendation Engine 125 and/or ML Engine 131. In some embodiments Processor 195 includes an integrated circuit configured for execution of a trained neural network.

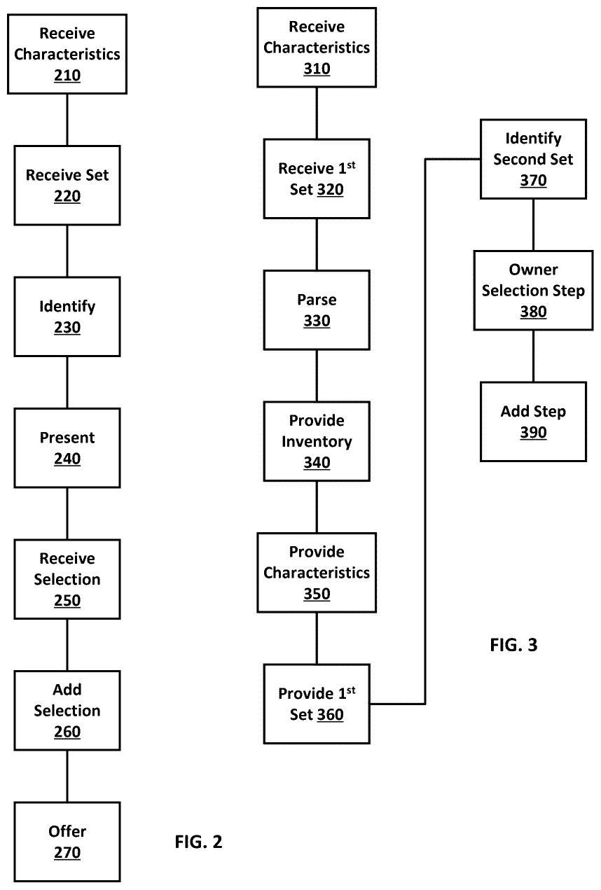

FIG. 2 illustrates methods of managing an e-commerce store including methods of adding inventory to a store, according to various embodiments of the invention. The store may be an e-commerce store and/or a brick & mortar store. The store may be associated with one or more influencers. The added inventory is optionally selected base on a probability that the inventor will cross-sell well with existing products at the store. The added inventory may also be selected in response to a social media account. The methods illustrated by FIG. 2 are optionally performed using E-commerce System 100 illustrated in FIG. 1.

In a Receive Characteristics Step 210 various characteristics of the e-commerce store are received. These characteristics can include, but are not limited to, the current available inventory of the store, products or services currently offered on the store, pricing and other product details, the purpose or niche of the store, the store's sales history, the history of customer interactions with the store, any relevant social media content related to the store, influencers associated with the store (and the characteristics of such influencers), and/or characteristics of a related physical store if one exists. Inventory information can include, for example, quantities, delivery time, prices, model numbers, locations, and/or the like. The characteristics may further include a virtual layout of the store in a virtual environment. Receive Characteristics Step 210 is optionally performed using Inventory Analysis Logic 129.

In a Receive Set Step 220 a set of available products from one or more external source is received. These external sources can include other e-commerce stores, wholesalers, manufacturers, or any other entities that supply products for sale. The one or more external supplier optionally includes at least one external e-commerce store. A pair of first and second e-commerce stores may be sources to each other. As such, they may cross-sell each other's products and/or services. Receive Set Step 220 is optionally performed using Store Parser Logic 127.

In a Identify Step 230 a selection of one or more products to be added or removed from the e-commerce store are identified. The selection is made from the set of available products received in Identify Step 230. The identification process is based on the characteristics of the e-commerce store received in Receive Characteristics Step 210 and is optionally made using a machine learning system or a knowledge graph (e.g., using ML Engine 132). The machine learning system is trained to identify products that are likely to increase profit, sales, customer visits, followers, and/or other desired outcomes at the e-commerce store. For example, the machine learning system or knowledge graph may be configured to identify products that cross-sell well together or would sell well as bundles. In some embodiments, Identify Step 230 is responsive to the availability of products at sources. Identify Step 230 is optionally performed using Recommendation Logic 128.

In a Present Step 240 the products identified in Identify Step 230 are presented to the owner of the e-commerce store. The owner can review the recommended products and make decisions about whether to add them to the store's inventory. Optionally, the owner is presented with an interface, e.g., a graphical user interface, that allows the owner to view potential products and automatically add them to a store using a “one-click” process. For example, Recommendation Logic 128 may suggest a product and also indicate which existing products would cross-sell with the suggested product, suggested pricing for the suggested product, sources for the suggested product, and/or predicted revenue resulting from the suggested product. The acceptance of a product may include receiving a suggestion and/or making a designation of which current store products would cross-sell with the accepted product. Acceptance of a product may also include suggestion and/or designation of where in a virtual store (e.g., in a metaverse) the accepted product should be placed/displayed. Present Step 240 is optionally performed using Product Browser 151.

In a Receive Selection Step 250 one or more selections of the identified products (or services) are received from the store owner. The owner makes these selections from among the identified products or services. The system is designed to make this process easy for the store owner, with options for drag-and-drop selection, one-click selection, product classification, image selection, pricing, related product suggestions, and/or other features. The owner can also designate special offers, upsell opportunities, and other sales strategies at this stage. The owner may select among several alternative sources for the product. Receive Selection Step 250 may also be performed using Product Browser 151. In exemplary embodiments, Receive Selection Step 250 includes receiving owner designated discount offers, product pairing suggestions, product descriptions, webpage template for the product, loyalty offers, product combination suggestions (bundle suggestions), and other customer retention strategies, and/or other sales enhancement strategies.

In the Add Selection Step 260, the selected products are added to the e-commerce store, optionally automatically. This automatic addition of products streamlines the process for the store owner, reducing the time and effort involved in manually adding each product. The addition of the selected products optionally includes the generation of a user interface (e.g., webpage) configured for a customer to view the selection of products and services. Via a template, this user interface can be customized to match the branding and aesthetic of the e-commerce store, providing a seamless shopping experience for the customer. The user interface may also be optimized for different devices, such as desktop computers, tablets, or mobile phones, ensuring that customers can easily view and purchase products regardless of the device they are using. The addition of the selected products optionally further includes the generation of a data record indicating the sources of and terms for the selected products or services. This data record can be used for inventory management, supplier relations, and sales tracking. The placement of a product within a store is optionally designed to optimize the store's navigation and product categorization based on the added products. This means that when new products are added, the system automatically updates the store's navigation menus and product categories to reflect the new additions. This automatic optimization ensures that the store remains easy to navigate and that products are easy to find, even as new products are added. This can lead to increased sales, as customers are more likely to purchase products if they can easily find what they are looking for. Add Selection Step 260 is optionally performed using elements of Store Manager 131. For example, Store Organization Logic 139 may be used to generate new search engine optimized web pages and navigation links between pages. The selected products may be displayed to a customer when the customer views a product that cross-sells well, or when the customer places the cross-selling product in a cart. Add Selection Step 260 optionally includes generation of alternative web pages for A/B testing. Add Selection Step 260 optionally includes transferring customer reviews from a source to the e-commerce store. For example, reviews made at one store may be copied to a second store.

In some embodiments, the manager of a source for a product is provided with an opportunity to agree or refuse to operate as a source for a particular influencer or e-commerce store.

In an optional Offer Step 270, one or more of the selected products are offered to a customer via a user interface, e.g., a web page of an e-commerce store and/or a social media feed. This offering can include presenting detailed product descriptions, images, or videos, reading customer reviews, or comparing the product with other similar products. The customer may also be able to view pricing information, including any discounts or special offers that may apply to the selected products. Offer Step 270 may include offering the customer the opportunity to add the selected products to their shopping cart, providing detailed product information, and other interactions. In a social media feed, the offering of a product may be as a posting, as a comment or response, in association with a specific image or posting by an influencer, and/or may be as an advertisement in the social media feed. In some embodiments, influencers are provided with a portable widget that can be posted on other influencers social media feeds as a comment. The widget can include promotion of a product to be sold, e.g., a link to a page at an e-commerce store that sells the product. The offer may include an estimated time of delivery based on a source of the product, an opportunity to pick up the product at a brick & mortar store associated with the e-commerce store, and/or an opportunity to pick up the product at a source of the product (e.g., a brick & mortar store of the source). Offer Step 270 is optionally responsive to any of the characteristics of the customer. For example, a customer in a first location may be offered the product responsive to the first location being close to a source of the product. Offer Step 270 may require a minimum inventory at a source of the product. For example, if the declared inventory falls below a minimum threshold across one or more sources, Offer Step 270 may be avoided until the inventory is replenished.

FIG. 3 illustrates methods of adding products to a social media feed, according to various embodiments of the invention. The products may be added as part of the social media feed, e.g., as a post or comment, and/or may be added to an e-commerce store associated with a social media feed/influencer account. For example, the products may be added to a social media feed including a stream of content shared on a social media platform by a user (e.g., influencer) or a group of users. The content can include text, images, videos, links, and other types of media. In the context of this disclosure, the social media feed is associated with a specific social media account and can be used as a platform for promoting and selling products. The products can be added manually or automatically by the store owner (e.g., an influencer) or automatically by a system based on various factors such as sales history, customer preferences, social media content, and/or any other of the store or influencer characteristics discussed herein. Specific postings or other content on the social media feed are optionally associated with specific pages and/or products of an e-commerce store.

One e-commerce store may be associated with a plurality of influencers. For example, a Shopify store managed using an owner of Store Builder 110 may have a variety of webpages, products, brands, etc. each associated with a different set of influencers and/or sets thereof. Alternatively, each influencer may be associated with a separate e-commerce store hosted on their own influencer website or an e-commerce platform. Typically, the influencer controls, e.g., owns, their customers. For example, the influencer may have more information about their customers than the social media platform with which the influencer is associated. In some embodiments, groups of influencers may group together in a “guild” and share a store or parts thereof. For example, a plurality of influencers focused on a similar topic (e.g., knitting or cooking) may group together to form a common e-commerce store. Once a customer visits this store, the customer may be offered products or services associated with more than one influencer. For example, a customer may be offered a cooking skillet from a first influencer and (as a cross-sell) a non-scratch spatula from a second influencer, where the first and second influencers are members of a “cooking” guild. Financial arrangements, e.g., referral fees and shared profits, may be established by the guild members and managed using Store Transaction Logic 133. The store may be configured to offer bundles of products promoted by different influencers. Likewise, in some embodiments, Recommendation Logic 128 is configured to suggest bundles of products or services.

The offered products may have different sources. The Influencers may or may not hold inventory to any of the products offered. For example, a first influencer who makes craft items may hold inventory in a first product that they make and a second influencer my not hold inventory but instead dropship products they sell from third party sources.

As used herein a “social media post” is a piece of content shared on a social media platform by a user. A post can include text, images, videos, links, and other types of media. In the context of this disclosure, a post can be used to promote a product available for sale in an associated e-commerce store. As used herein a social media comment is a response or reaction to a post on a social media platform. A comment can include text, images, videos, links, and other types of media. In the context of this disclosure, a comment can be used to promote a product available for sale in an associated e-commerce store.

In a Receive Characteristics Step 310, various characteristics of a social media account are received. These characteristics can include a wide range of characteristics. For example, a current inventory of products or services being promoted on the social media account and/or associated e-commerce store, a stated purpose or theme of the social media account, a social media feed of the social media account, characteristics of one or more influencers associated with the social media account, and/or a history associated with the account. The characteristics related to the account can include, for example, customer and influencer characteristics, data on past sales volumes, revenue, and/or customer conversion rates. The customer characteristics can include data on customer demographics, purchasing behaviors, and interactions with the social media account. Identifiers of followers of the social media account may also be received. These identifiers can include follower usernames, profile information, and engagement metrics. The social media content received can encompass a variety of media types, including text posts, audio clips, images, and videos. The social media feed, which is the stream of content shared on the social media account, can include the account's own posts as well as posts from other users that the account follows or interacts with. The social media content received may further include an identifier of a social media platform, an owner's profile information, posting habits, follower count, and/or engagement metrics.

If the social media account is associated with a physical (brick & mortar) store, characteristics of this related physical store are optionally also received. The physical store characteristics may include the store's location, size, product range, layout, sales data, and customer demographics.

The social media content may include, for example, postings including textual content, such as status updates, tweets, or captions; postings including audio content, such as voice messages or audio clips; postings including image content, either still or video, such as photos, illustrations, or video clips; and follower responses to postings, such as comments, reposts, likes, shares, or retweets.

In a Receive First Set Step 320, a first set of available products from one or more external sources is received. These external sources can include other e-commerce stores, wholesalers, manufacturers, or any other entities that supply products for sale. In some embodiments, the one or more external sources optionally include at least one external e-commerce store. This external e-commerce store could be a standalone online store or part of a larger online marketplace. The products received from these external sources can include a wide range of goods or services, depending on the nature of the e-commerce store and the preferences of the store owner.

In an optional Parse Step 330 the social media content is parsed to generate tokens representative of the social media content included in the social media account, the social media content optional including a social media feed. Parsing of the social media content optionally includes generation of tokens representative of the content of text, audio, images and/or videos as discussed elsewhere herein. The social media content can be any content associated with the social media account, including but not limited to posts, comments, likes, shares, and other interactions. The social media content may also include a social media feed, which is a stream of content shared on the social media platform by the account owner or other users.

For example, the parsing process may involve analyzing the social media content and generating tokens that represent the content. These tokens serve as a simplified representation of the content, making it easier for the system to analyze and understand the content. The tokens can represent various types of content, including text, audio, images, and videos. For example, text content can be tokenized into individual words or phrases, audio content can be tokenized into sound bites or transcriptions, image content can be tokenized into expressions of the content, visual features or labels, and video content can be tokenized into frames or segments. The parsing process can also involve various techniques and algorithms, such as natural language processing for text content, audio signal processing for audio content, image recognition for image content, and video analysis for video content. The generated tokens can then be used as input for the machine learning system, which uses these tokens to identify products that are likely to increase sales at the e-commerce store. Examples of image parsing discussed elsewhere herein may be included in Parse Step 330.

In an optional Provide Inventory Step 340, the current inventory of an e-commerce store associated with the social media account is provided to a trained machine learning system, e.g., to ML Engine 132. The machine learning system is trained to identify products likely to increase sales at the e-commerce store. More specifically, the machine learning system may be trained to identify products that cross-sell together or that promote up-sales of products. The machine learning system may make use of a knowledge graph of products or product characteristics represented by nodes, wherein branches between the nodes of the graph represent cross-selling or up-sell strength.

As discussed elsewhere herein, ML Engine 132, may be trained to identify products that are likely to increase sales at the e-commerce store. This could be products that are popular, trending, or have a high conversion rate. More specifically, the ML Engine 132 may be trained to identify products that are likely to cross-sell together. Cross-selling is a sales technique where the seller encourages the customer to purchase additional items that are related or complementary to the product they are already buying or viewing. For example, if a customer is buying a camera, a cross-sell product may be a camera case or extra memory card. Upselling is a type of cross-selling in which more expensive products are offered to a customer, optionally as an alternative to a product they have shown interest in. For example, a customer that has shown interest in a camera may be offered a more expensive camera.

A subset of cross-selling is up-selling in which a customer is offered a more expensive or advanced product relative to a product they have shown interest in. ML Engine 132 may also be trained to identify products that promote up-sales. Up-selling is a sales technique where the seller encourages the customer to purchase a more expensive version of the product they are already buying or to add on extra features or services. For example, if a customer is buying a basic model of a camera, an up-sell product could be a higher-end model of the same camera or additional warranty service.

In some embodiments, ML Engine 132 is configured to make use of a knowledge graph to identify these cross-sell and up-sell products. A knowledge graph is a graph-based data structure used to represent knowledge in a machine-readable format. In this case, the knowledge graph represents products or product characteristics as nodes, and the relationships between these nodes are represented as branches. The strength of the cross-selling relationship between two products is optionally represented by the weight of the branch connecting the nodes. For example, if two products often sell together, the branch connecting them in the knowledge graph would have a high weight. This allows the machine learning system to quickly and efficiently identify products that are likely to cross-sell well together.

In a Provide Characteristics Step 350, the social media content and/or the representative tokens are provided to the machine learning system.

In a Provide First Set Step 360, the first set of available products is provided to the machine learning system. For example, Provide First Step 360 may include providing the machine learning system with data about the products that are currently available from one or more external sources. These external sources can include other e-commerce stores, wholesalers, manufacturers, or any other entities that supply products for sale. The data about the available products can include a wide range of information such as product details, pricing, delivery options, quantity, geographical information, etc. This data is used by the machine learning system to identify products that are likely to increase sales or profits at the e-commerce store.

In a Identify Second Set Step 370 a second set of one or more products is identified using the machine learning system. The second set is identified based on: the first set of available products, the social media content (or representative tokens), and/or the current inventory. The second set of products includes candidate products to be added to an e-commerce store associated with the social media account. The second set is selected from the from set of available products. For example, the identification by the machine learning system may be based on the provided social media content or the tokens, characteristics of the social media account. Parse Step 330 is optional in embodiments in which the social media content is not used in the identification of the second set.

In a Identify Second Set Step 370 a second set of one or more products is identified using the machine learning system. The second set is identified based on: the first set of available products, the social media content (or representative tokens) and/or the current inventory. The second set of products includes candidate products to be added to an e-commerce store associated with the social media account. The second set is selected from the from set of available products. For example, the identification by the machine learning system may be based on the provided social media content or the tokens, characteristics of the social media account. Parse Step 330 is optional in embodiments in which the social media content is not used in the identification of the second set.

Typically, the machine learning system identifies these products by analyzing the provided social media content or the tokens, and the characteristics of the social media account. For instance, the machine learning system may analyze the social media content, which could include posts, comments, likes, shares, and other interactions on the social media account. It may also analyze the tokens, which are representative of the social media content and provide a simplified representation of the content, making it easier for the machine learning system to understand and analyze the content.

The machine learning system may also consider the characteristics of the social media account (e.g., characteristics of associated influencers) in the product identification process. These characteristics could include the purpose or theme of the account, the account's follower count, the account's posting frequency, and other relevant factors. By considering these factors, the machine learning system can identify products that are likely to appeal to the followers of the social media account and thus increase sales, etc. at the e-commerce store.

It's worth noting that the Parse Step 330, which involves parsing the social media content to generate tokens representative of the content, is optional in embodiments where the social media content is not used in the identification of the second set of products. In such cases, the machine learning system may rely more heavily on other factors, such as the first set of available products and the current inventory of the e-commerce store, in the identification process.

In an optional Owner Selection Step 380 the second set of one or more products is presented to an owner of the e-commerce store associated with the social media account and one or more selection by the owner of products is received from among the second set. Alternatively, the second set may automatically be added to the e-commerce store without review by the owner.

In an optional Owner Selection Step 380, the second set of one or more products is presented to an owner of the e-commerce store associated with the social media account. The owner is then given the opportunity to make one or more selections from among the second set of products. This step allows the owner to have direct input into the inventory of their e-commerce store, ensuring that the products align with their business strategy, target audience, and brand image. The owner can review the recommended products, evaluate their potential impact on the store's sales and profit, and make informed decisions about whether to add them to the store's inventory. The presentation of the second set of products typically includes information related to each product such as financial terms, reviews, inventory availability, delivery times, and/or the like. Some products may be associated with more than one source.

The presentation of the second set of products to the owner can be facilitated by a user-friendly interface, which displays detailed information about each product, including its description, price, source, reviews, inventory, predicted sales performance, and/or other product information discussed herein. The interface may also provide tools for the owner to sort, filter, and compare the products, making the selection process more efficient and effective.

In an illustrative example, products of the second set may be presented to the owner in a graphical user interface. The owner (e.g., an influencer) can then select products they want to add to their e-commerce store using a “1-click” process. As noted elsewhere herein, such addition can include automatic generation of associated product webpages, etc. on the e-commerce store. Selecting a product may include agreeing to financial terms and other conditions associated with the product. Optionally, bundles of individual products may be added as a group.

Once the owner has made their selection, the selected products are received from the owner by the system. This can be done through various methods, such as clicking on a “select” button next to each product, dragging and dropping the products into a “selected” area, or ticking checkboxes next to the products. The owner's selections are then recorded and used in the subsequent steps of the method.

Alternatively, if the owner prefers not to manually select the products, the second set of products may automatically be added to the e-commerce store without review by the owner. This can be particularly useful for owners who manage large e-commerce stores with a wide range of products, as it can save them time and effort. The automatic addition of products can be based on predefined criteria set by the owner, such as the products' predicted sales performance, profit margin, or relevance to the store's target audience. The owner can also set the system to automatically add new products that match the store's existing inventory or business strategy. For example, an owner may choose to automatically add specific categories of products, products bundles, products with certain financial criteria (e.g., profit margin), products with quantitative cross-sell potential above a threshold, and/or the like.

In an Add Step 390 one or more products from among the second set are added to the e-commerce store. Optionally, the added products are limited to those in the selection received from the owner and/or that satisfy criteria for automatic addition. In some embodiments, the addition of the selection of products includes generation of a user interface configured (e.g., webpage or social media post) for a customer to view the selection of products and/or including generation of a data record indicating sources of the selected products or services.

In Add Step 390, the system proceeds to incorporate one or more products from the second set into the e-commerce store. The products that are added are not arbitrary but are chosen from the second set of products which have been identified by the machine learning system as likely to increase sales at the e-commerce store. Optionally, the products that are added to the e-commerce store are limited to those that have been selected by the store owner from the second set. This gives the store owner the ability to have final say over which products are added to their store, ensuring that the added products align with their business strategy and brand image.

In some embodiments, the addition of the selected products to an e-commerce store involves the generation of a user interface. This user interface, which could be a webpage or a social media application interface, is configured for a customer to view (and purchase) the selection of products.

Typically, the addition of the selected products also includes the generation of a data record. This data record indicates the sources of the selected products or services, providing valuable information for inventory management and supplier relations. The data record can include details such as the product name, product description, product price, source name, source location, source alternatives, and other relevant information. This data record can be used for various purposes, such as tracking inventory levels, analyzing sales data, training a machine learning system, identifying correlations between product sales, managing supplier relationships, and more. The data record may be, for example, stored in Storage 190 for use by Store Manager 131.

The methods illustrated by FIG. 3 are optionally performed using the elements illustrated in FIG. 1, as discussed elsewhere herein. For example, Parse Step 330 may be performed using Feed Parser 143 and Image Processor 145; Receive Characteristics Step 310 may be performed using Media Account Manager 147. Identify Second Set Step 370 may be performed using Recommendation Logic 128, Connection Processor 149 and ML Engine 132. Owner Selection Step 380 may be performed using Owner Device 118A and Product Browser 151. Add Step 390 may be performed using Store Organization Logic 139.

One difference between the methods illustrated in FIGS. 2 and 3 is that product selection in the methods of FIG. 3 may rely solely on social media content, rather than or in addition to inventory of an existing e-commerce store. Thus, the methods of FIG. 3 may result in the addition of products that “cross-sell” with social media content rather than or in addition to cross-selling with other products. The methods of FIG. 3 may identify products that merely sell well based on the social media content without regard to other products promoted is association with the social media account. The methods of either FIG. 2 or 3 are optionally used to develop new stores in situations where existing inventories do not yet exist.

FIG. 4 illustrates methods of generating an e-commerce store associated with an influencer, according to various embodiments. Such methods may be used across a social media platform to create numerous e-commerce stores each associated with a respective influencer account. For example, one of Social Media Applications 123 may use the methods of FIG. 4 to create many (e.g., thousands of) customized e-commerce stores each associated with one or more of the top influencers on the respective social media platform. The resulting e-commerce stores may be hosted on the social media platform itself and/or hosted on a marketplace such as Shopify, Squarespace, WooCommerce, etc. The methods illustrated by FIG. 4 are optionally performed using the systems illustrated in FIG. 1.

In a Choose Influencer Step 410 an influencer is selected from among the plurality of influencers that may have accounts on one of Social Media Applications 123. If the influencer themselves is the party performing the method of FIG. 4, then Choose Influencer Step 410 merely includes self-selection. A marketing manager or the manager of a social media platform may choose influencers based on an account status, account activity, a number of followers, and/or the like. For example, a social media platform may offer e-commerce to the top influencers in terms of follower count, postings, etc. and/or influencers who pay for a premium account. The methods illustrated by FIG. 4 may be repeated for many influencers. Choose Influencer Step 123 is optionally performed using Media Account Manager 147 and/or Social Media Applications 123.

In a Gather Influencer Characteristics Step 420 characteristics of an influencer are gathered. These characteristics can include any combination of the influencer characteristics discussed elsewhere herein. For example, the gathering of influencer characteristics may include retrieval of an influencer's location, a summation of the characteristics of their followers, and/or analysis of their social media feed using Feed Parser 143 (e.g., using Parse Step 330). Gather Influencer Characteristics Step 420 is optionally performed using Media Manger 141. Optionally, Gather Influencer Characteristics Step 420 is performed as part of Choose Influencer Step 410 and the gathered information is used in the selection of one or more influencer.

In a Recommend Step 430 one or more products and/or services are recommended for inclusion in an e-commerce store associated with the chosen influencer. This store may be new or pre-existing. For example, knitting products may be recommended for an e-commerce store associated with an influencer who often discusses knitting on their social media feed. In some embodiments, an initial set of products or services is recommended by default, e.g., 5, 10 or 20 products. These recommendations may be automatically added to a new e-commerce store, optionally following approval by the chosen influencer.

Products added to a new store, e.g., a store without an existing inventory and/or sales history, may be recommended based on characteristics of an influencer, e.g., contents of their social media feed, stated purpose of the store, the age, gender and/or location of the influencer, characteristics of their followers, and/or any other influencer characteristics discussed herein. As such, ML Engine 132 is optionally trained to make recommendations based on these influencer characteristics, without necessarily the use of existing inventory and/or sales data for the (new) store. In such cases, ML Engine 132 is configured to predict what an influencer will be able to sell well at an e-commerce store associated with the influencer, before any sales are made via the e-commerce store.

Additional products and/or services may then be added to the e-commerce store by the influencer using, for example, the methods illustrated by FIG. 3. The recommended products optionally being associated with specific product sources and the recommendations optionally including characteristics of the products and/or sources. For example, a recommendation may include delivery, inventory, pricing and/or other source characteristics/terms discussed herein. A recommendation may include more than one source, each having different characteristics.

In some embodiments, Recommend Step 430 includes analysis of a first influencer's followers (and/or any other characteristics of the influencer) and comparison of this influencer's followers (and/or characteristics) with that of other influencers that have e-commerce stores. The products may then be recommended based on what products sell well at influencers that have similar characteristics, e.g., follower characteristics. For example, for an influencer who is 15 years old and commonly posts videos about makeup, Recommend Step 430 may recommend products that sell well on e-commerce sites featuring 15-year-old influencers who are focused on makeup or beauty products. Such recommendations may be made using Recommendation Engine 125 and/or Media Manager 141. Of course, once an influencer's store includes an initial inventory, the methods illustrated by FIGS. 2 & 3 may be used to expand the inventory.

In some embodiments, the products and/or services recommended in Recommend Step 430 are recommended based on an influencer's activity outside of the (first) social media platform. For example, if an influencer has an existing e-commerce store (possibly associate with a second social media platform) activity on this second social media platform or this existing e-commerce store may be considered in recommendation of products for a new e-commerce store associated with the first social media platform. In some embodiments, the existing and new e-commerce stores may be combined into a single e-commerce store associated with two or more social media accounts that may be based on different social media platforms. As such, a single influencer and/or e-commerce store managed by Store Bulder 110 may be associated with multiple social networks supported by multiple members of Social Media Applications 123.

Recommendation Step 430 is optionally performed using an instance of ML Engine 132 configured to receive the influencer's characteristics and to output suggested products (and/or services) based on these characteristics. Such an instance of ML Engine 132 may be trained using the characteristics of other influencers and data regarding the products (and/or services) sold at e-commerce stores associated with the other influencers.

In an Add Product Step 440 one or more recommended products are added to an e-commerce store associated with an influencer. The addition of products may or may not be subject to approval by the chosen influencer or a representative thereof in an Approve Step (not shown). Such Approve Step may be similar to Owner Selection Step 380. In some embodiments an e-commerce store is established using an initial set of products and/or services. The number of initial products may be based on strengths of the recommendations made in Recommendation Step 430. For example, the initial products may include a few products that are highly recommended and/or some products for which the recommendation is less certain. Further products and/or services may then be added using the methods illustrated in FIG. 3, the further products optionally being recommended based, at least in-part, on sales of the initial set.

A source of a recommended product may be automatically selected. Or an influencer may select both a product/service and a source associated therewith. Sources may be selected based on any of the characteristics on which products/services are selected. Further, sources may be selected based on location, financial terms, shipping costs, source reviews or performance, and/or the like. In some embodiments, more than one source is selected for a product/service. For example, if an influencer has followers in both Europe and Asia then both a European source and an Asian source may be selected. In another example, if the characteristics of an influencer indicate that their followers value prompt delivery over price then a source capable of prompt delivery may be chosen over a source having favorable price terms. Of course, in some embodiments, both sources may be selected and the determination of which source to use may be made at the time a purchase is made based on customer characteristics.

Store Transaction Logic 133 is optionally configured to share revenue resulting from recommended products between any combination of a manger of Store Builder 110, the chosen influencer, an e-commerce platform, and the social media platform used by the influencer. The social media platform may be a social media platform supported by one of Social Media Applications 123 or another content distribution platform such as a podcasting services, a blog service, a news website, a journal/magazine website, a video distribution service, an app store, and/or the like.

Several embodiments are specifically illustrated and/or described herein. However, it will be appreciated that modifications and variations are covered by the above teachings and within the scope of the appended claims without departing from the spirit and intended scope thereof. For example, e-commerce can include interaction (e.g., shopping and purchasing) with products viewed on a display within a physical store. An e-commerce store is an online platform where goods or services are bought and sold. The e-commerce store can be a standalone website or a part of a larger online marketplace. In the context of this disclosure, the e-commerce store is associated with a specific social media account and can be used to sell products promoted on the social media feed or in a store associated with or integrated with the social media feed or social media profile thereof.

The products and services discussed herein optionally include advertisements (as a product) and advertising services. For example, an advertising agency or an advertisement distribution service may make use of the systems and methods discussed herein to serve advertisements to social media feeds and/or e-commerce stores. Such advertisements may include affiliate links that allow for revenue sharing between the advertising service and a store owner or social media influencer. If a product being added to an e-commerce store is an advertisement, the product would be considered for “presentation to a customer” but not for “sale to a customer. ” The owner of an e-commerce store or an influencer may use the methods described herein to select which advertisements are added to their stores. In some embodiments, characteristics of a product may include an inventory of advertisements for that product. For example, if a store owner of adds a product to a store, they may receive an inventory of online advertisements for that product, or other products at their store. Provision of the inventor of advertisements may be used, (by an owner of a source of the products, by a manufacturer, by a manager of Store Builder 110, by an advertising service, and/or the like,) to encourage store owners and/or influencers to add products or services to their stores. Such advertisements may direct potential customers to the e-commerce store and/or to a page of the e-commerce store offering the product. Specifically, a product may come with an inventory of 10,000 impressions of advertisements for that product and the store owner may “spend” these impressions via an advertising agency. In alternative embodiments, other incentives, (such as money, free products or discounted products), may be offered to influencers to add products to their stores.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

Any of the elements illustrated in FIG. 1 can include logic configured to perform the functions associated with those elements. The logic discussed herein is explicitly defined to include hardware, firmware or software stored on a non-transient computer readable medium, or any combinations thereof. This logic may be implemented in an electronic and/or digital device (e.g., a circuit) to produce a special purpose computing system. Any of the systems discussed herein optionally include a microprocessor, including electronic and/or optical circuits, configured to execute any combination of the logic discussed herein. The methods discussed herein optionally include execution of the logic by said microprocessor.

Computing systems and/or logic referred to herein can comprise an integrated circuit, a microprocessor, a personal computer, a server, a distributed computing system, a communication device, a network device, or the like, and various combinations of the same. A computing system or logic may also comprise volatile and/or non-volatile memory such as random access memory (RAM), dynamic random access memory (DRAM), static random access memory (SRAM), magnetic media, optical media, nano-media, a hard drive, a compact disk, a digital versatile disc (DVD), optical circuits, and/or other devices configured for storing analog or digital information, such as in a database. A computer-readable medium, as used herein, expressly excludes paper. Computer-implemented steps of the methods noted herein can comprise a set of instructions stored on a computer-readable medium that when executed cause the computing system to perform the steps. A computing system programmed to perform particular functions pursuant to instructions from program software is a special purpose computing system for performing those particular functions. Data that is manipulated by a special purpose computing system while performing those particular functions is at least electronically saved in buffers of the computing system, physically changing the special purpose computing system from one state to the next with each change to the stored data.

1. An e-commerce system comprising:
a store manager configured for a store owner to view and modify characteristics of an e-commerce store;
a machine learning system trained to identify combinations of products that sell well together;
a recommendation engine including:
a store parser configured to identify a set of products or services available from external e-commerce stores,
inventory analysis logic configured to identify characteristics of the e-commerce store, the characteristics including at least a current listed inventory of the e-commerce store, and
recommendation logic configured to use the machine learning system to generate recommendations of additional products to add to the e-commerce store based on at least the identified set of products and the current listed inventory;
a product browser configured for the store owner to review the generated recommendations and to select products from the generated recommendations to be added to the e-commerce store;
storage configured to store the characteristics of the e-commerce store, data characterizing the set of products available from external e-commerce stores, and/or the machine learning system; and
a microprocessor configured to execute at least part of the recommendation engine.

2. An e-commerce system comprising:
a store manager configured for a store owner to view and modify characteristics of an e-commerce store;
statistical analysis logic configured to identify combinations of products that sell well together;
a recommendation engine including:
a store parser configured to identify a set of products or services available for drop shipping from external sources,
inventory analysis logic configured to identify characteristics of the e-commerce store, the characteristics including at least a current listed inventory of the e-commerce store, and
recommendation logic configured to use statistical analysis logic to generate recommendations of additional products to add to the e-commerce store based on at least the identified set of products and the current listed inventory;
a product browser configured for the store owner to review the generated recommendations and to select products from the generated recommendations to be added to the e-commerce store;
storage configured to store the characteristics of the e-commerce store, data characterizing the set of products available from external e-commerce stores, and/or the machine learning system; and
a microprocessor configured to execute at least part of the recommendation engine.

3. A method of managing an e-commerce store, the method comprising:
receiving characteristics of the e-commerce store, the received characteristics including one or more of: a current inventory, a store purpose, a sales history, a customer history, social media content, and/or characteristics of a related physical store;
receiving a set of available products available from one or more external supplier, the one or more external supplier including at least one external e-commerce store;
identifying a selection of one or more products to be added or removed from the e-commerce store, the selection being from the set of available products, wherein the identification is based on the characteristics of the e-commerce store, and the identification is made using a machine learning system or statistical analysis logic trained to identify products likely to increase profit (sales, etc.) at the e-commerce store;
presenting the identified products to an owner of the e-commerce store;
receiving one or more selection of products from among the identified products or services, the selection being received from the owner;
automatically adding the selection of products to the e-commerce store, the addition of the selection of products including generation of a user interface configured for a customer to view the selection of products and services and including generation of a data record indicating sources of the selected products or services; and
optionally presenting the user interface to a customer.

4. The system of claim 1, wherein the store manager includes source logic configured to track sources of products offered on the e-commerce store, the sources including physical inventory and/or external e-commerce stores.

5. The system of claim 1, wherein the store manager includes logistics logic and store transaction logic, the logistics logic being configured to manage delivery of purchased products from sources to customers, the store transaction logic being configured to execute financial transactions in exchange for products or services, the financial transactions optionally including both payments to the e-commerce store and payments to one or more sources.

6. The system of claim 1, wherein the store manager includes inventory sharing logic configured for a store owner to designate which products offered within a (physical and/or virtual) store may be sourced to an external e-commerce store.

7. The system of claim 1, wherein the machine learning system is trained to generate one or more product recommendations each of the recommendations being associated with a product class or associated with a product included in the current listed inventory.

8. The system of claim 1, wherein the recommendation engine is configured to gather inventory quantity information, retail price, reseller discount, and/or shipping information from the external ecommerce stores.

9. The system of claim 1, wherein the recommendation logic is further configured to generate recommendations for product bundles that are likely to be purchased together based on historical sales data and customer purchasing behavior, the product bundles including products sourced from 2 or more independent e-commerce stores.

10. The system of claim 1, wherein the presentation of identified products to the store owner includes a one-click feature that allows the store owner to quickly add recommended products to the e-commerce store, the addition including automatic addition of the identified products to a website of the store owner.

11. The system of claim 1, wherein the store owner is an influencer and the recommendation engine is configured to recommend products based at least in part on a social media feed of the influencer.

12. The system of claim 1, wherein the user interface presented to the customer is dynamically generated to highlight the added selection of products based on the customer's previous browsing behavior or purchase history.

13. The system of claim 1, wherein a product or service is associated with an inventory of advertisements configured to promote the product or service.

14. The system of claim 2, wherein the recommendation engine is configured to perform A/B testing on products recommended by the machine learning system.

15. The system of claim 2, wherein the characteristics of the e-commerce store include: A/B test results, past sales data, data used to identify customers, store organization, out of stock inventory, current listed inventory, store theme, and/or social media feed.

16. The system of claim 1, wherein the store parser is further configured to analyze inventory and sales data from other independent e-commerce stores and sources, including but not limited to, wholesale suppliers and manufacturers.

17. The system of claim 2, wherein the product browser provides a user interface that allows the store owner to simulate potential sales outcomes based on the recommended products before making a selection.

18. The method of claim 3, wherein the automatic addition of the selection of products to the e-commerce store includes optimization of the store's navigation and product categorization based on the added products.

19. The method of claim 3, wherein the generation of a data record indicating sources of the selected products or services includes tracking of inventory levels and reorder points for each product, facilitating automatic reordering from suppliers when inventory is low.

20. The method of claim 3, wherein addition of a product or service to an e-commerce store includes receiving an inventory of advertisement to promote the e-commerce store.
